(19) United States
(12) Patent Application Publication
(10) Pub. No.: US 2006/0043899 A1
(43) Pub. Date: Mar. 2, 2006

(54) Electric lamp

(75) Inventors: Bodo Mittler, Stadtbergen (DE); Andreas Naujoks, Birkenwerder (DE)

Correspondence Address: OSRAM SYLVANIA INC, 100 ENDICOTT STREET, DANVERS, MA, 01923, US

(73) Assignee: PATENT-TREUHAND-GESELLSCHAFT Fur elektrische Gluhlampen mbH, MUNCHEN (DE)

(21) Appl. No.: 11/201,335

(22) Filed: Aug. 11, 2005

(30) Foreign Application Priority Data
Aug. 25, 2004 (DE) 10 2004 041 296.0

(51) Int. Cl. H01J 61/30; H01J 17/16

(52) U.S. Cl. 313/634

(57) ABSTRACT

An electric lamp having at least one transparent lamp vessel which has at least one sealed end through which at least one power supply line for a luminous element is passed which is arranged in the interior of the at least one lamp vessel, the at least one power supply line including a metal foil embedded in the at least one sealed end, characterized in that the metal foil extends at least up to that side of the sealed end which is remote from the interior of the lamp vessel, the at least one power supply line being passed out of the sealed end.

### I. TECHNICAL FIELD

The invention relates to an electric lamp having at least one transparent lamp vessel which has at least one sealed end through which at least one power supply line for a luminous element is passed which is arranged in the interior of the at least one lamp vessel, the at least one power supply line comprising a metal foil embedded in the at least one sealed end.

### II. BACKGROUND ART

Such an electric lamp has been disclosed, for example, in the European patent specification EP 0 884 763 B1. This specification describes an electric lamp having a lamp vessel which has a sealed end out of which a power supply line is passed, the power supply line comprising a molybdenum foil embedded in the sealed end. A first end of the molybdenum foil is welded to an electrode rod protruding into the interior of the lamp vessel, while the opposite, second end of the molybdenum foil is welded to a power supply wire protruding out of the lamp vessel. In order to prevent cracks or flaws in the glass surrounding the molybdenum foil, the molybdenum foil is in the form of a wedge at its first end, as a rolled cutting edge. It has been shown that, despite this measure, cracks or flaws can still occur in the glass surrounding the molybdenum foil, to be precise in particular in the region of the second end of the molybdenum foil which is welded to the power supply wire.

### III. DISCLOSURE OF THE INVENTION

It is the object of the invention to provide a generic electric lamp having an improved lamp vessel seal.

This object is achieved according to the invention by an electric lamp having at least one transparent lamp vessel which has at least one sealed end through which at least one power supply line for a luminous element is passed which is arranged in the interior of the at least one lamp vessel, the at least one power supply line comprising a metal foil embedded in the at least one sealed end, wherein said metal foil extends at least up to that side of said sealed end which is remote from the interior of the lamp vessel, the at least one power supply line being passed out of said sealed end. Particularly advantageous embodiments of the invention are described in the dependent patent claims.

The electric lamp according to the invention has at least one transparent lamp vessel which has at least one sealed end through which at least one power supply line for a luminous element is passed which is arranged in the interior of the lamp vessel, the at least one power supply line comprising a metal foil embedded in the at least one sealed end. According to the invention, the metal foil extends at least up to that side of the sealed end which is remote from the interior of the lamp vessel, the at least one power supply line being passed out of said sealed end. This measure can prevent cracks or flaws in the sealed end of the lamp vessel.

The invention has proved to be particularly successful in the case of lamps subjected to high thermal loads, such as high-pressure discharge lamps, whose discharge vessel is usually made from quartz glass, i.e. from a glass having a silicon dioxide content of at least 95 percent by weight, since with these lamps, owing to the extremely different coefficients of thermal expansion of the power supply parts, which are usually made from molybdenum or tungsten, and of the quartz glass surrounding them, the risk of the occurrence of cracks or flaws in the sealed end is particularly high. The abovementioned lamps have a discharge vessel made from quartz glass which is sealed at at least one end, and whose at least one sealed end has a current feedthrough for a gas discharge electrode which protrudes into the discharge space of the discharge vessel, a first end of the metal foil embedded in the at least one sealed end being connected to the gas discharge electrode, while the second end of the metal foil extends at least up to that side of the at least one sealed end of the discharge vessel which is remote from the discharge space in order to avoid the occurrence of cracks or flaws in the at least one sealed end.

The abovementioned metal foils are preferably molybdenum foils which are usually used for the purpose of sealing lamp vessels made from quartz glass. The surface of the molybdenum foils may have a coating, for example made from ruthenium, in order to improve the corrosion resistance of the molybdenum foil or the seal between the molybdenum foil and the quartz glass.

### IV. BRIEF DESCRIPTION OF THE DRAWINGS

The invention will be explained in more detail below with reference to a preferred exemplary embodiment. In the drawings:

FIG. 1 shows a schematic illustration of a sealed end of a lamp vessel of an electric lamp according to the invention,

FIG. 2 shows a schematic illustration of the end (depicted in FIG. 1) of the lamp vessel in a side view rotated through an angle of 90 degrees with respect to FIG. 1,

FIG. 3 shows a schematic illustration of the lamp in accordance with the preferred exemplary embodiment of the invention,

FIG. 4 shows a schematic illustration of the lamp in accordance with the second exemplary embodiment of the invention, and

FIG. 5 shows a schematic illustration of the lamp in accordance with the third exemplary embodiment of the invention.

### V. BEST MODE FOR CARRYING OUT THE INVENTION

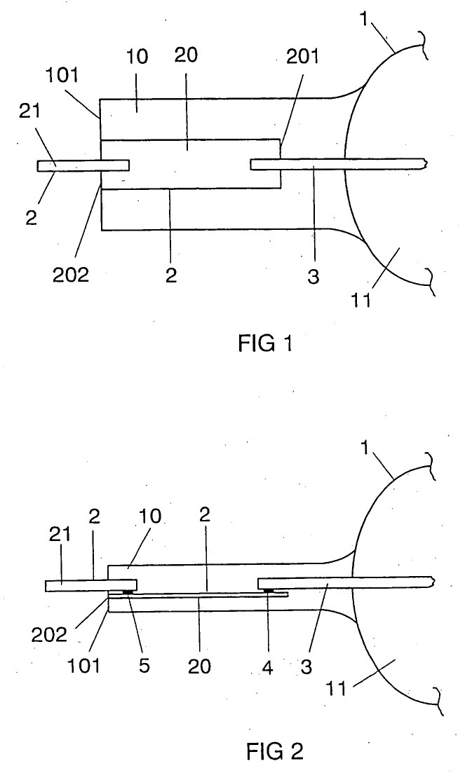

FIGS. 1 and 2 show schematic illustrations of a sealed end 10 of a glass discharge vessel 1 of a high-pressure discharge lamp. Embedded in the sealed end 10 is a metal foil 20 which is part of a power supply line 2 for the gas discharge electrode 3 protruding into the interior or discharge space 11 of the discharge vessel 1. That first end 201 of the metal foil 20 which faces the interior 11 of the discharge vessel 1 is arranged so as to overlap with the rod-shaped gas discharge electrode 3, and the gas discharge electrode 3 is connected to the metal foil 20 by means of a weld 4 at a small distance from the foil edge. That second end 202 of the metal foil 20 which is remote from the interior 11 is arranged so as to overlap with the power supply wire 21 which is connected to the metal foil 20 by means of a weld 5 at a small distance from the edge of the end 202. The second end 202 of the metal foil 20 extends up to the end side 101 of the sealed end 10 of the discharge vessel 1, the power supply wire 21 being passed out of said discharge vessel 1. The sealed end 10 is in the form of a so-called pinch seal, i.e. the glass of the originally tubular end of the discharge vessel was softened by heating and pinched tightly over the metal foil 20 such that the metal foil 20 is embedded in the glass of the sealed end 10 in the region between the power supply wire 21 and the gas discharge electrode 3.

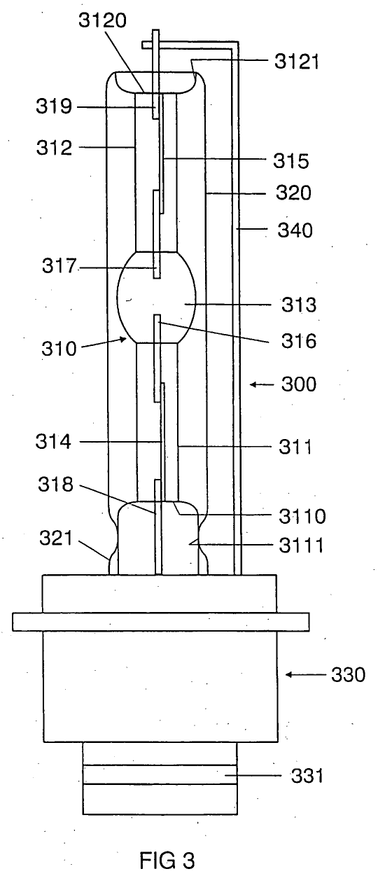

FIG. 3 shows a schematic illustration of an electric lamp in accordance with the preferred exemplary embodiment of the invention. This lamp is a halogen metal-vapor high-pressure discharge lamp 300 for a motor vehicle headlight having an electrical power consumption of approximately 35 watts. This lamp 300 has a discharge vessel 310 made from quartz glass which is surrounded by an outer bulb 320 which is made from quartz glass provided with additives which absorb UV rays. The two lamp vessels 310, 320 are fixed in the base 330 which is equipped with the electrical connections of the lamp 300. The discharge vessel 310 is sealed at two ends. It has a first sealed end 311 close to the base and a second sealed end 312 remote from the base. The ends 311, 312 are arranged diametrically with respect to the two sides of the discharge space 313 of the discharge vessel 310. Embedded in each of the two ends 311, 312 of the discharge vessel 310 is a molybdenum foil 314, 315 which are each connected, at their end which faces the discharge space 313, to a gas discharge electrode 316 and 317, respectively, which protrudes into the discharge space 313 and comprises a tungsten pin. That end of the molybdenum foils 314 and 315 which is remote from the discharge space 313 is in each case connected to a power supply wire 318 and 319, respectively, which is made from molybdenum and is passed out of the respective sealed end 311 and 312 of the discharge vessel 310. The molybdenum foils 314, 315 extend in each case up to that end side 3110 and 3120, respectively, of the sealed ends 311 and 312, respectively, of the discharge vessel 310 which is remote from the discharge space 313. Adjacent to those sides of the sealed ends 311, 312 of the discharge vessel 310 which are remote from the discharge space 313 is, in each case, a circular-cylindrical discharge vessel section 3111, 3121, at which the outer bulb 320 is fused with the discharge vessel 310. A base-side, tubular extension 321 of the outer bulb 320 is fixed in the base 330. The power supply wire 319, which is passed out of that end 312 of the discharge vessel 310 which is remote from the base, is passed back to the base 330 via the power return line 340 and electrically conductively connected to the annular electrical connection 331, while the power supply wire 318, which is passed out of the end 311 near to the base, is electrically conductively connected to an electrical connection in the form of an axial contact pin (not visible in FIG. 3).

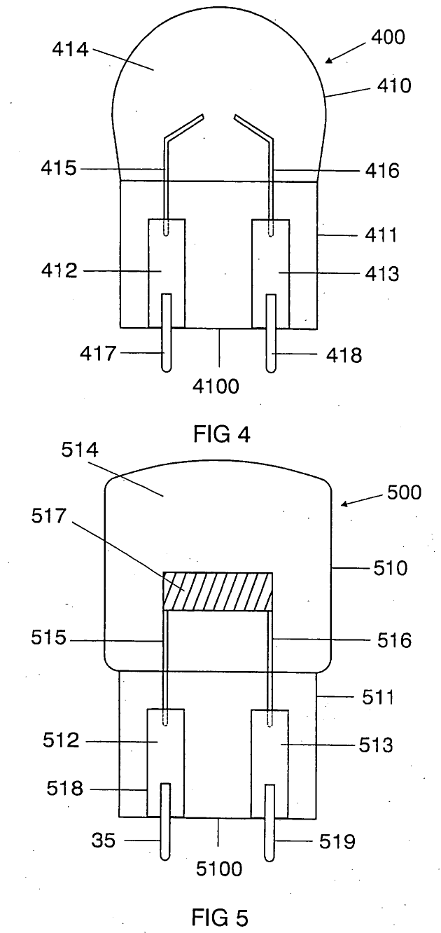

FIG. 4 depicts a high-pressure discharge lamp 400 in accordance with the second exemplary embodiment of the invention. This lamp 400 has a discharge vessel 410 made from quartz glass which is sealed at one end 411. Embedded in the sealed end 411 are two molybdenum foils 412, 413 which are each connected, at their end which faces the discharge space 414, to a gas discharge electrode 415, 416 which protrudes into the discharge space 414. That end of the molybdenum foils 412, 413 which is remote from the discharge space is in each case connected to a power supply wire 417, 418 which is passed out of the discharge vessel 410. The two molybdenum foils 412, 413 extend up to that end side 4100 of the discharge vessel 410 which is remote from the discharge space 414, the power supply wires 417, 418 protruding out of said discharge vessel 410. The third exemplary embodiment of the invention depicted in FIG. 5 is a halogen incandescent lamp 500 having a lamp vessel 510 made from quartz glass. Embedded in the sealed end 511 are two molybdenum foils 512, 513 which are each connected, at their end which faces the interior 514 of the lamp vessel 510, to an outgoing filament section 515, 516 of the incandescent filament 517 arranged in the interior 514. That end of the molybdenum foils 512, 513 which is remote from the interior 514 is in each case connected to a power supply wire 518, 519 which is passed out of the lamp vessel 510. The two molybdenum foils 512, 513 extend up to that end side 5100 of the lamp vessel 510 which is remote from the interior 514, the power supply wires 518, 519 protruding out of said lamp vessel 510.

The invention is not restricted to the exemplary embodiments explained in more detail above. For example, the molybdenum foils may also protrude out of the respective sealed end, and the power supply wires may be correspondingly shortened. In addition, for example in the exemplary embodiment depicted in FIG. 3, the end sides 3110 and 3120 of the sealed discharge vessel ends 311, 312 may each be coated with a glass solder or another anti-corrosion agent. In all of the above-described exemplary embodiments, extending the molybdenum foils up to the end side of the lamp vessel, from which the power supply wires protrude, markedly reduces the risk of the formation of cracks in the sealed end. Only the region of the molybdenum foils between the respective power supply wire and the corresponding gas discharge electrode or the corresponding outgoing filament section is embedded in a gas-tight manner in the quartz glass of the lamp vessel. In order to reduce the risk of corrosion of the molybdenum foils, they may be provided with a coating, for example made from ruthenium.

What is claimed is:

1. An electric lamp having at least one transparent lamp vessel which has at least one sealed end through which at least one power supply line for a luminous element is passed which is arranged in the interior of the at least one lamp vessel, the at least one power supply line comprising a metal foil embedded in the at least one sealed end, wherein said metal foil extends at least up to that side of said sealed end which is remote from the interior of the lamp vessel, the at least one power supply line being passed out of said sealed end.

2. The electric lamp as claimed in claim 1 having a discharge vessel made from quartz glass which is sealed at at least one end, and whose at least one sealed end has a current feedthrough for a gas discharge electrode which protrudes into the discharge space of the discharge vessel, a first end of the metal foil embedded in the at least one sealed end being arranged so as to overlap with the gas discharge electrode, wherein the second end of the metal foil extends at least up to that side of the at least one sealed end of the discharge vessel which is remote from the discharge space.

3. The electric lamp as claimed in claim 1, wherein the metal foils are in the form of molybdenum foils.

4. The electric lamp as claimed in claim 2, wherein the metal foils are in the form of molybdenum foils.
